(19) United States
(12) Patent Application Publication
(10) Pub. No.: US 2025/0337085 A1
(43) Pub. Date: Oct. 30, 2025

(54) BATTERY STRUCTURE OF ELECTRIC VEHICLE

(71) Applicant: Ford Global Technologies, LLC, Dearborn, MI (US)

(72) Inventors: Dave Souch, Alresford (GB); Jonathan Mooney, Epping (GB); Vaibhav Khotre, Eastbourne (GB)

(73) Assignee: Ford Global Technologies, LLC, Dearborn, MI (US)

(21) Appl. No.: 18/650,762

(22) Filed: Apr. 30, 2024

(51) Int. Cl. H01M 50/262; B60K 1/04; B60L 50/64; H01M 50/211

(52) U.S. Cl. CPC H01M 50/262; B60K 1/04; B60L 50/64; H01M 50/211; B60K 2001/0438; H01M 2220/20

(57) ABSTRACT

A battery structure for an electric vehicle includes first and second battery arrays. The first battery array includes first walls that are secured to each other to form a first unitized structure that is configured to house first battery cells. One first wall of the plurality of first walls extends in a transverse direction relative to a longitudinal direction of the electric vehicle. The second battery array is adjacent to the first battery array and includes second walls that are secured to each other to form a second unitized structure that is configured to house second battery cells. One second wall of the plurality of second walls is secured to the first wall of the first battery array and includes a first vertical portion, a second vertical portion spaced apart from the first vertical portion and connecting members connecting the first vertical portion and the second vertical portion.

### FIELD

The present disclosure relates to a battery structure and more particularly to a battery structure for an electric vehicle.

### BACKGROUND

The statements in this section merely provide background information related to the present disclosure and may not constitute prior art.

Electric vehicles differ from conventional motor vehicles because they are driven by one or more rechargeable battery packs having lithium-ion batteries, for example, or any other suitable electrical power storage units. The battery pack typically powers one or more motors to drive a set of wheels using battery arrays. In some electric vehicles, the battery arrays include a structural assembly that surrounds battery pouches, especially for vehicles capable of traveling long distances (e.g., electric vehicles capable of traveling more than 500 miles).

The present disclosure addresses these and other issues related to battery arrays in electric vehicles.

### SUMMARY

This section provides a general summary of the disclosure and is not a comprehensive disclosure of its full scope or all of its features.

In one form, the present disclosure provides a battery structure for an electric vehicle including a first battery array and a second battery array. The first battery array includes a plurality of first walls that are secured to each other to form a first unitized structure that is configured to house first battery cells. One first wall of the plurality of first walls extends in a transverse direction relative to a longitudinal direction of the electric vehicle. The second battery array is adjacent to the first battery array and includes a plurality of second walls that are secured to each other to form a second unitized structure that is configured to house second battery cells. One second wall of the plurality of second walls is secured to the first wall of the first battery array and includes a first vertical portion, a second vertical portion spaced apart from the first vertical portion and connecting members connecting the first vertical portion and the second vertical portion.

In variations of the battery structure of the above paragraph, which can be implemented individually or in any combination: the first wall includes a third vertical portion and a flange portion extending from the third vertical portion toward the second battery array; the second vertical portion of the second wall is spaced apart from the third vertical portion of the first wall; the flange portion is located above the second vertical portion of the second wall and located above the connecting members of the second wall; first fasteners extend through the flange portion of the first wall and through one of the connecting members of the second wall to secure the first wall to the second wall; a battery tray is configured to house the first battery array and the second battery array; a plurality of second fasteners, each second fastener extending through the connecting members and at least partially through a bottom wall of the battery tray to secure the second wall to the battery tray; a battery tray configured to house the first battery array and the second battery array; a plurality of fasteners, each fastener extending through the connecting members of the second wall and at least partially through a bottom wall of the battery tray to secure the second wall to the battery tray; a third battery array adjacent to the first battery array and connected to the another first wall of the first battery array; and a height of the first vertical portion of the second wall is greater than a height of the second vertical portion of the second wall.

In another form, the present disclosure provides a battery structure for an electric vehicle including a battery tray, a plurality of cross beams, and a plurality of battery arrays. The plurality of cross beams are secured to the battery tray and are spaced apart from each other along a longitudinal direction of the electric vehicle. Each cross beam extends in a transverse direction. The plurality of battery arrays are disposed within the battery tray. The plurality of battery arrays include a first battery array and a second battery array. The first battery array includes a plurality of first walls that are secured to each other to form a first unitized structure that is configured to house first battery cells. One first wall of the plurality of first walls includes a first vertical portion and a flange portion extending from the first vertical portion. The second battery array is adjacent to the first battery array and includes a plurality of second walls that are secured to each other to form a second unitized structure that is configured to house second battery cells. One second wall of the plurality of second walls is supported by a corresponding cross beam of the plurality of cross beams and includes a second vertical portion, a third vertical portion spaced apart from the second vertical portion and connecting members connecting the second vertical portion and the third vertical portion. The flange portion of the first wall is secured to the second wall.

In variations of the battery structure of the above paragraph, which can be implemented individually or in any combination: the third vertical portion of the second wall is spaced apart from the first vertical portion of the first wall; the flange portion is located above the third vertical portion of the second wall and located above the connecting members of the second wall; a plurality of fasteners, each fastener extending through the connecting members and a corresponding cross beam to secure the second wall to the battery tray; a plurality of first fasteners extending through the flange portion of the first wall and through one of the connecting members of the second wall to secure the first wall to the second wall; a plurality of second fasteners, each second fastener extending through each of the connecting members and a corresponding cross beam to secure the second wall to the battery tray; the plurality of first fasteners have a first length and the plurality of second fasteners have a second length, the second length greater than the first length; the flange portion of the first wall abuts again the second vertical portion of the second wall; and a third battery array adjacent to the first battery array and connected to the another first wall of the first battery array.

In yet another form, a method for assembling a battery structure of an electric vehicle is provided. The method includes disposing a first battery array within a battery tray, securing the first battery array to the battery tray; disposing a second battery array within the battery tray after the first battery array is secured to the battery tray, and securing the second battery array to the first battery array. The first battery array includes a first wall including a first vertical portion, a second vertical portion spaced apart from the first vertical portion and connecting members connecting the first vertical portion and the second vertical portion. The second battery array includes a second wall having a vertical portion and a flange portion extending from the vertical portion.

In variations of the battery structure of the above paragraph, securing the second battery array to the first battery array comprises inserting a plurality of fasteners through the flange portion of the second wall and through one of the connecting members of the first wall.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a schematic view of a vehicle including a battery housing assembly according to the principles of the present disclosure;

FIG. 2 is a perspective view of the battery housing assembly of FIG. 1;

FIG. 3 is another perspective view of the battery housing assembly of FIG. 1 illustrated with battery arrays and a lid of the battery housing assembly removed for clarity;

FIG. 4 is another perspective view of the battery housing assembly of FIG. 1 including battery arrays disposed therein and with the lid of the battery housing assembly removed for clarity;

FIG. 5 is a perspective view of one battery array of the battery housing assembly of FIG. 1;

FIG. 6 is another perspective view of one battery array of the battery housing assembly of FIG. 1;

FIG. 7 is a cross-sectional view of a portion of the battery housing assembly of FIG. 1;

FIG. 8 is another cross-sectional view of a portion of the battery housing assembly of FIG. 1;

FIGS. 9A-9D are diagrammatical views of battery arrays being assembled to each other and to a battery tray of the battery housing assembly of FIG. 1; and

FIG. 10 is a flow diagram illustrating a method for manufacturing a battery housing assembly according to the principles of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

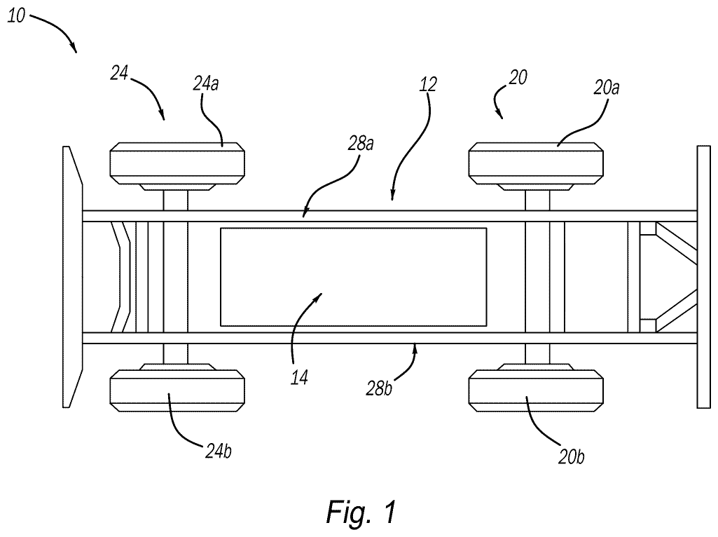

With reference to FIG. 1, a vehicle 10 such as an electric vehicle is shown. In the example provided, the electric vehicle is a battery electric vehicle (BEV). In other examples, the electric vehicle may be a hybrid electric vehicle (HEV), a plug-in electric vehicle (PHEV), or a fuel cell vehicle, among others. The vehicle 10 includes a vehicle frame 12 and a battery structure or battery housing assembly 14. The vehicle frame 12 is the main supporting structure of the vehicle 10, to which various components are attached either directly or indirectly. The vehicle frame 12 includes opposed longitudinal rails 28a, 28b. The rails 28a, 28b are spaced apart from each other and may establish a length of the vehicle frame 12. In the example illustrated, the vehicle 10 is a body on frame vehicle architecture, though other configurations can be used, such as a unibody architecture, for example.

The battery housing assembly 14 powers a rear motor (not shown) to drive rear wheels 20a, 20b of a set of rear wheels 20 via a rear axle and/or powers a front motor (not shown) to drive front wheels 24a, 24b of a set of front wheels 24 via a front axle.

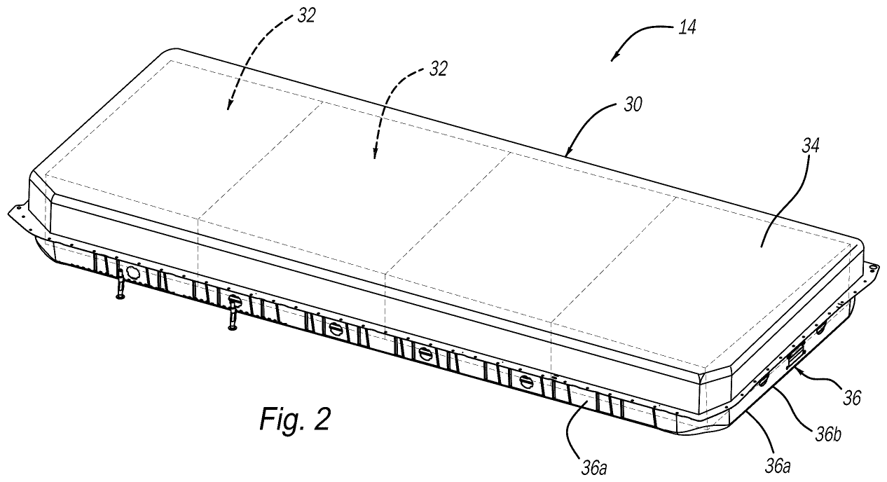

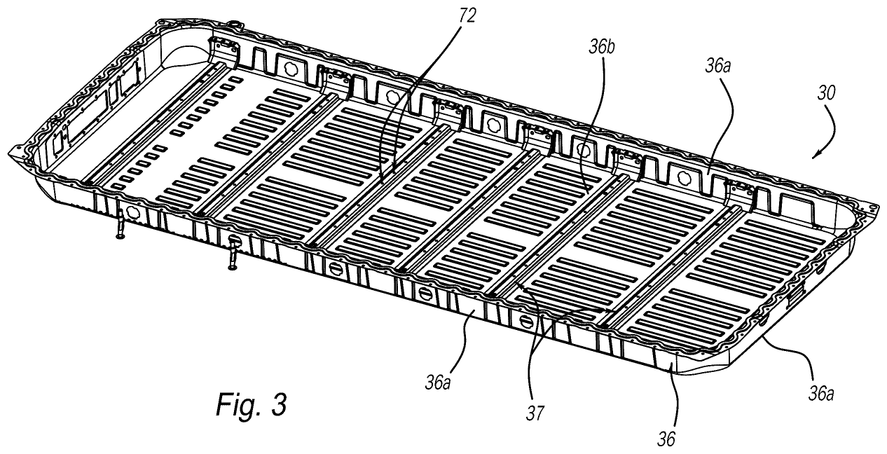

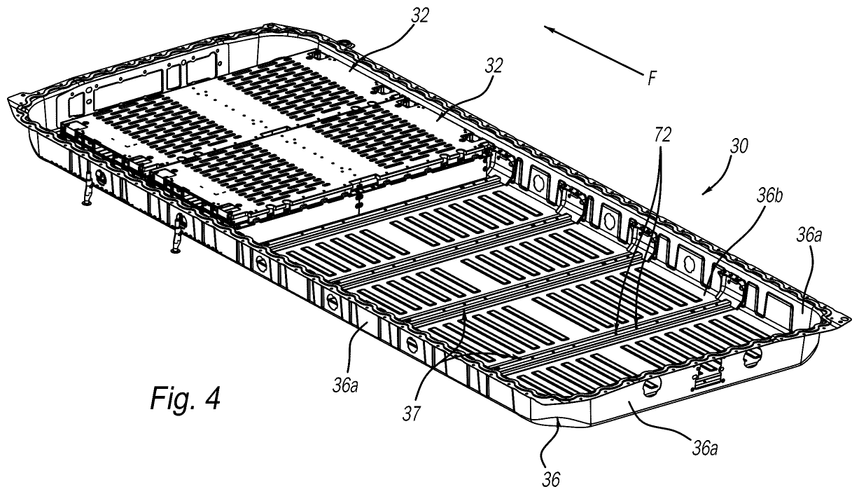

With reference to FIGS. 2-6, the battery housing assembly 14 includes a battery tray or housing 30 and a plurality battery arrays 32 (FIGS. 2 and 4-6). The battery housing 30 is an enclosure which provides a structural surrounding and sealed compartment for the battery arrays 32 and other battery components such as cooling lines, support brackets, and wiring disposed therein or extending therethrough. The battery housing 30 may be disposed at various locations of the vehicle 10 and is mounted to the vehicle frame 12. In this way, the battery housing 30 is supported by the vehicle frame 12 and is remote from a passenger cabin (not shown) and cargo compartments (not shown) of the vehicle 10, therefore, not occupying space that would otherwise be available for passengers or cargo. The battery housing 30 includes a cover or lid 34 (FIG. 2), a body 36 (FIGS. 2-4), a plurality of cross beams 37 (FIGS. 3 and 4), and a seal (not shown). The lid 34 is removably coupled to the body 36 via mechanical fasteners such as bolts or screws (not shown), for example. In this way, the lid 34 may be removed to service the battery arrays 32 disposed within the battery housing 30.

The body 36 includes one or more side walls or panels 36a and a bottom wall or panel 36b. The side walls 36a are manufactured via stamping, for example, and extend in a vertical direction. The side walls 36a define an outer boundary of the battery housing 30 and are secured to each other via welding or an adhesive, for example. The bottom wall 36b supports the battery arrays 32 disposed within the battery housing 30 and is secured to lower portions of the side walls 36a.

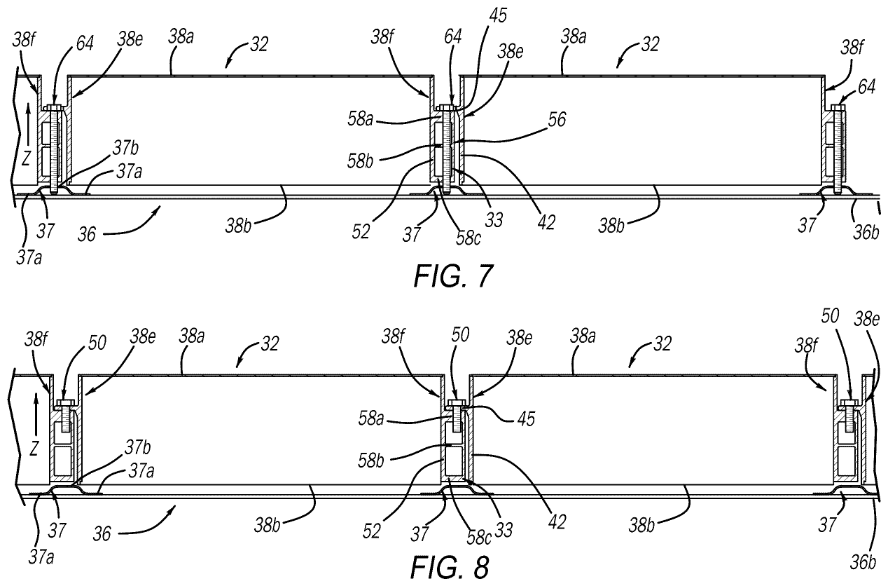

With additional reference to FIGS. 7 and 8, the cross beams 37 are supported on and secured to the bottom wall 36b of the body 36 and are evenly spaced apart from each other in a longitudinal direction of the vehicle 10. Each cross beam 37 also extends in a transverse direction of the vehicle 10 and at least partially supports adjacent battery arrays 32 of the battery housing assembly 14. Each cross beam 37 includes a pair of end portions 37a and a central portion 37b. The pair of end portions 37a are secured to an upper surface of the bottom wall 36b of the battery housing 30. In one example, the pair of end portions 37a are secured to the upper surface of the bottom wall 36b by welding. In some forms, the pair of end portions 37a are secured to the upper surface of the bottom wall 36b by mechanical fasteners such as rivets, threaded screws, and/or bolts, for example. The central portion 37b is located above the pair of end portions 37a and has a planar surface. The central portion 37b and the bottom wall 36b of the battery housing 30 cooperate to form a cavity. The seal is disposed around a periphery of the body 36 and is engaged with the body 36 and the lid 34. In this way, fluids, debris and other materials are inhibited from entering into the battery housing 30.

With reference to FIGS. 2, 5, and 6, the plurality of battery arrays 32 are disposed within the battery housing 30. In the example illustrated, the battery arrays 32 are arranged within the battery housing 30 in a side-by-side arrangement to form a lower row of battery arrays. In some forms, battery arrays (not shown) may be arranged within the battery housing 30 in a side-by-side arrangement and located on top of the battery arrays 32 to form an upper row of battery arrays. Each battery array of the upper row of battery arrays may be vertically stacked on top of a respective battery array 32 of the lower row of battery arrays.

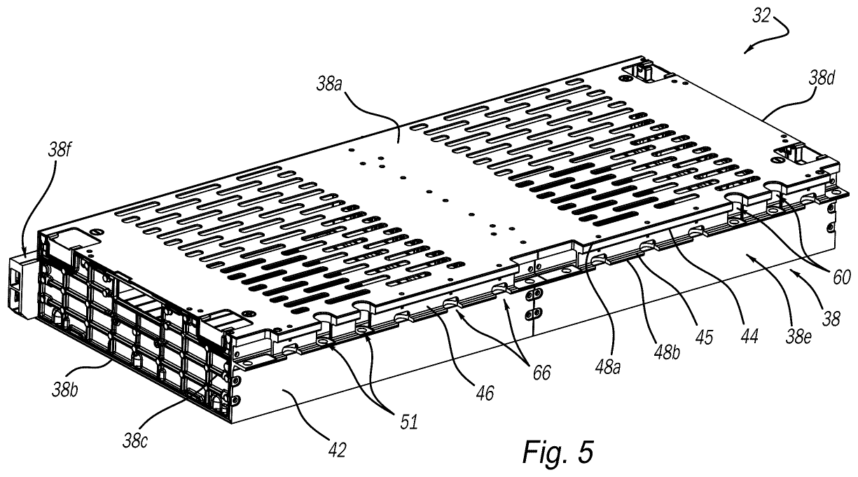

Each battery array 32 may be rechargeable and may be in the form of a modular structure that can be installed within and removed from the battery housing 30. Each battery array 32 also spans substantially an entire width of the battery housing 30. With reference to FIGS. 5-7, each battery array 32 includes a plurality of walls 38 that are secured to each other to form a unitized structure that houses and supports one or more cell stacks (not shown) formed by battery cells (e.g., lithium-ion batteries or any other suitable electrical power storage units). In some forms, the battery cells may be stacked on each other in a vertical arrangement within the unitized structure. In some forms, the battery cells may be arranged in a side-by-side configuration within the unitized structure.

The battery arrays 32 are secured to each other to form a structural assembly that is configured to transfer loads from one side of the battery housing 30 to an opposite side of the battery housing 30, for example, during a certain impact event. Stated differently, the battery arrays 32 are secured to each other to transfer loads away from the cell stacks (not shown) located within each battery array 32 during a certain impact event.

The plurality of walls 38 of each battery array 32 include an upper wall 38a, a lower wall 38b, a right-side wall 38c, a left side wall 38d, a front wall 38e and a rear wall 38f. Each of the walls 38a-38f are secured to each other to form a structural surrounding and sealed compartment for the cell stack. In the example illustrated, the structural surrounding has a box shape. The upper wall 38a defines an uppermost boundary of the battery array 32 and is oriented in a horizontal direction. Similarly, the lower wall 38b defines a lowermost boundary of the battery array 32a and is oriented in a horizontal direction. The right-side wall 38c is oriented vertically and defines a rightmost boundary of the battery array 32. Similarly, the left side wall 38d is oriented vertically and defines a leftmost boundary of the battery array 32.

Referring to FIGS. 5, 7 and 8, the front wall 38e of each battery array 32 is located further toward a front end of the vehicle 10 (arrow F in FIG. 4 indicates front end of the vehicle 10) than the rear wall 38f of the battery array 32 and is secured to the rear wall 32f of an adjacent battery array 32. In this way, the front wall 38e of the battery array 32 and the rear wall 38f of the adjacent battery array 32 form a cross member or structure 33 that spans substantially an entire width of the battery housing 30 and that is configured to transfer loads from one side of the battery housing 30 to an opposite side of the battery housing 30, for example, during a certain impact event. It should be understood that the battery array 32 located furthest forward in the battery housing 30 is secured to a structure 40 disposed within the battery tray 30. Stated differently, the front wall 38e of the battery array 32 located furthest forward in the battery housing 30 is secured to the structure 40.

The front wall 38e of the battery array 32 includes a vertical portion 42, a first upper portion or flange portion 44, a second upper portion or flange portion 45 and a connecting member 46. The vertical portion 42 extends in a vertical direction and faces the rear wall 38f of an adjacent battery array 32. In the example illustrated, a lower end of the vertical portion 42 is flush with the lower wall 38b of the battery array 32 and an upper end of the vertical portion 42 is underneath the upper wall 38a of the battery array 32. In some forms, the lower end of the vertical portion 42 may extend downward past the lower wall 38b of the battery array 32 and the upper end of the vertical portion 42 may extend upward past the upper wall 38a of the battery array 32.

The first upper portion 44 extends perpendicular from an upper end of the vertical portion 42 towards the rear wall 38f of the adjacent battery array 32. The first upper portion 44 of the battery array 32 located furthest forward in the battery housing 30 extends perpendicular from the upper end of the vertical portion 42 towards the structure 40 disposed within the battery tray 30. The first upper portion 44 is oriented horizontally and is secured to the upper wall 38a of the battery array 32. The first upper portion 44 includes a plurality of openings (not shown) extending therethrough that receive fasteners (not shown) to secure the upper wall 38a of the battery array 32 to the front wall 38e of the battery array 32.

The second upper portion 45 extends perpendicular from a location of the vertical portion 42 that is between the upper end and the lower end of the vertical portion 42 towards the rear wall 38f of the adjacent battery array 32. The second upper portion 45 is oriented horizontally and is spaced apart from the first upper portion 44. In the example illustrated, the first upper portion 44 has a thickness that is greater than a thickness of the second upper portion 45. The second upper portion 45 includes a plurality of openings 51 (FIG. 5) extending therethrough that receive fasteners 50 to secure the front wall 38e of the battery array 32 to the rear wall 38f of the adjacent battery array 32. The openings 51 are offset from the openings (not shown) formed in the first upper portion 44 (i.e., the openings 51 of the second upper portion 45 are not vertically aligned with the openings in the first upper portion 44).

The connecting member 46 is oriented in a vertical direction and connects the first upper portion 44 and the second upper portion 45 to each other. In the example illustrated, the connecting member 46 extends from the first upper portion 44 at a location near a middle region of the first upper portion 44 to the second upper portion 45 at a location near a middle region of the second upper portion 45. In this way, the connecting member 46 is spaced apart from the vertical portion 42. In some forms, the connecting member 46 is spaced apart from ends 48a, 48b of the first and second upper portions 44, 45, respectively. In other forms, the connecting member 46 extends from the end 48a of the first upper portion 44 to the end 48b of the second upper portion 45.

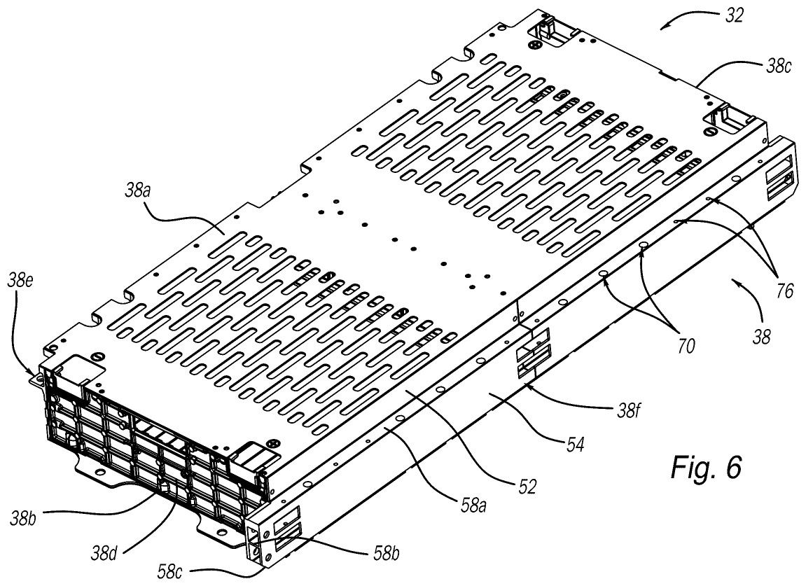

With reference to FIGS. 6-8, the rear wall 38f of the battery array 32 is secured to a corresponding cross beam 37 disposed within the battery housing 30. The rear wall 38f is also secured to the front wall 38e such that a minimal gap 56 is defined between the rear wall 38f and the vertical portion 42 of the front wall 38e (FIGS. 7 and 8) of the adjacent battery array 32. The rear wall 38f includes a first vertical portion 52, a second vertical portion 54, and a plurality of connecting members 58a, 58b, 58c. The first vertical portion 52 extends in a vertical direction and is spaced apart from the vertical portion 42 of the front wall 38e of the adjacent battery array 32. In the example illustrated, the first vertical portion 52 is underneath the upper wall 38a of the battery array 32 and is located above the bottom wall 38b of the battery array 32.

The second vertical portion 54 extends in a vertical direction and is spaced apart from the vertical portion 42 of the front wall 38e of the adjacent battery array 32. Stated differently, the second vertical portion 54 is located closer to the vertical portion 42 of the front wall 38e of the adjacent battery array 32 than the first vertical portion 52, and cooperates with the vertical portion 42 to define the minimal gap 56 therebetween. In the example illustrated, the first vertical portion 52 extends further in a Z-direction than the second vertical portion 54. The second vertical portion 54 also extends underneath the first upper portion 44 and the second upper portion 45 of the front wall 38e of the adjacent battery array 32.

The connecting members 58a, 58b, 58c are spaced apart from each other along the Z-direction and connect the first vertical portion 52 of the rear wall 38f to the second vertical portion 54 of the rear wall 38f. Stated differently, the connecting members 58a, 58b, 58c extend perpendicular from the first vertical portion 52 to the second vertical portion 54 and are oriented in the horizontal direction with gaps therebetween. In the example illustrated, each of the connecting members 58a, 58b, 58c may have a different thickness. For example, the connecting member 58a may have a thickness that is greater than thicknesses of the connecting members 58b, 58c and the connecting member 58c may have a thickness that is greater than a thickness of the connecting member 58b. In some forms, the thickness of each of the connecting members 58a, 58b, 58c may be the same. In the example illustrated, the connecting member 58c is disposed over the central portion 37b of the corresponding cross beam 37 such that the rear wall 38f is spaced apart from the bottom wall 36b of the battery housing 30.

In the example illustrated, fasteners 50 extend through the second upper portion 45 of the front wall 38e of the battery array 32 and through the connecting member 58a of the rear wall 38f of the adjacent battery array 32 in order to secure the battery array 32 and the adjacent battery array 32 to each other. In some forms, the fasteners 50 may extend through the second upper portion 45 of the front wall 38e of the battery array 32 and through the connecting members 58a, 58b, 58c to secure the battery array 32 and the adjacent battery array 32 to each other. As shown in FIG. 5, grooves or cutouts 60 may be formed in portions of the front wall 38e and the upper wall 38a to provide access to the second upper portion 45 of the front wall 38e. In this way, the fasteners 50 do not contact the first upper portion 44 of the front wall 38e and the upper wall 38a of the battery array 32.

In the example illustrated, fasteners 64 extend through the connecting members 58a, 58b, 58c of the rear wall 38f of the battery array 32 and through the central portion 37b of the corresponding cross beam 37 in order to secure the battery array 32 to the battery housing 30. In some forms, the fasteners 64 may extend through the connecting members 58a, 58b, 58c of the rear wall 38f of the battery array 32, through the central portion 37b of the corresponding cross beam 37 and at least partially through the bottom wall 36b of the battery housing 30 to secure the battery array 32 to the battery housing 30. Each fastener 64 has a length that is greater than a length of the fastener 50. As shown in FIG. 5, grooves or cutouts 66 may be formed in portions of the front wall 38e to occupy or house a head of each fastener 64 extending through the connecting members 58a, 58b, 58c. In this way, the fasteners 64 do not contact the front wall 38e and the upper wall 38a of the battery array 32.

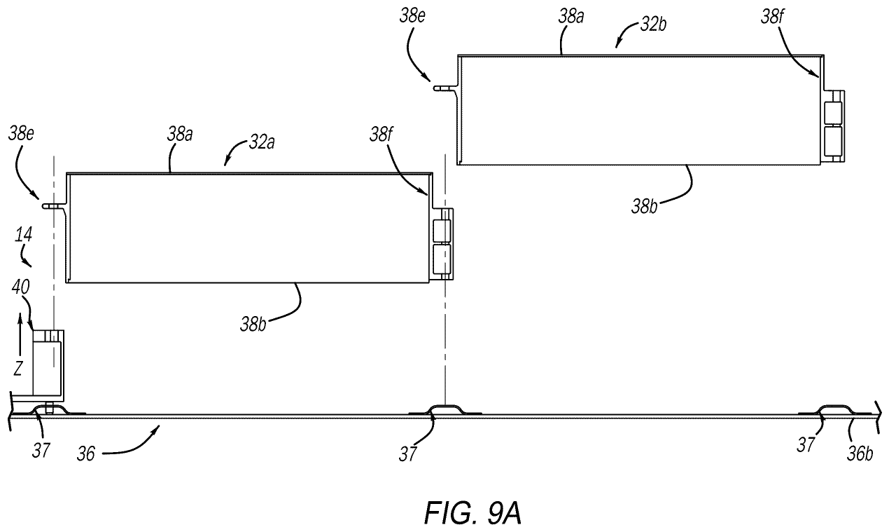

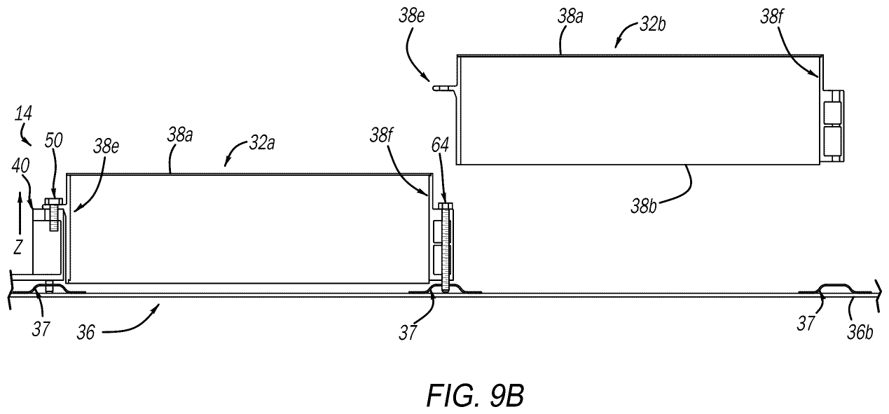

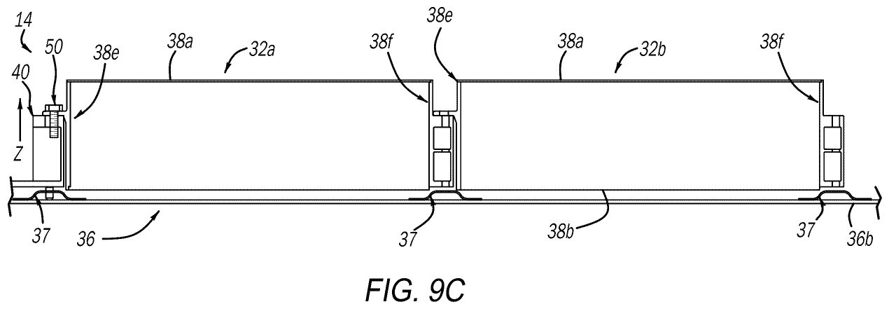

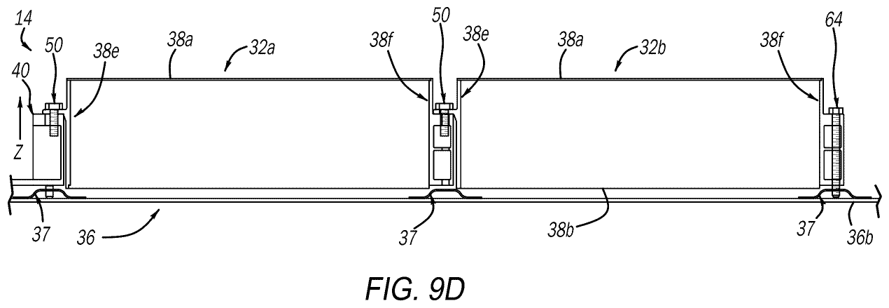

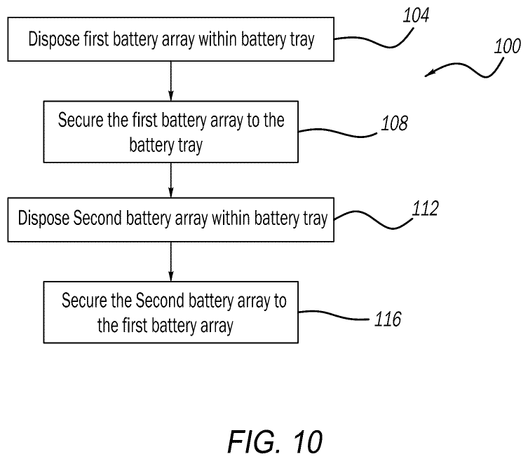

With reference to FIGS. 9A-9D and FIG. 10, a method 100 for assembling a battery structure 14 of an electric vehicle will be described in detail. At 104, the battery array 32a of a plurality of battery arrays 32 is disposed within the battery tray 30 (FIG. 9A). At 108, the battery array 32a is secured to the battery tray 30. That is, the front wall 38e of the battery array 32a located furthest forward in the battery housing 30 is secured to the structure 40 (FIG. 9B) of the battery housing 30 using the fasteners 50 and the rear wall 38e of the battery array 32a is secured to the battery tray 30 using fasteners 64.

At 112, another battery array 32b of a plurality of battery arrays 32 is disposed within the battery tray 30 adjacent to the battery array 32a (FIG. 9C). At 116, the battery array 32b is secured to the battery tray 30 and is secured to the battery array 32a (FIG. 9D). That is, the rear wall 38f of the battery array 32b is secured to the battery tray 30 by inserting the fasteners 64 through openings 70 (FIG. 6) of the connecting members 58a, 58b, 58c and an opening 72 (FIGS. 3 and 4) of a corresponding cross beam 37 secured to the battery tray 30. The front wall 38e of the battery array 32b is secured to the rear wall 38f of the battery array 32a by inserting each fastener 50 through a corresponding opening 51 of the front wall 38e of the battery array 32b and through a corresponding opening 76 (FIG. 6) of the connecting member 58a of the rear wall 38f of the battery array 32a. Additional battery arrays 32 are disposed within the battery tray 30 and are secured to each other and to the battery tray 30 one after another similar to the method described above until the desired number of battery arrays 32 are disposed within the battery tray 30.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A battery structure for an electric vehicle, the battery structure comprising:
a first battery array comprising a plurality of first walls that are secured to each other to form a first unitized structure that is configured to house first battery cells, one first wall of the plurality of first walls extends in a transverse direction relative to a longitudinal direction of the electric vehicle; and
a second battery array adjacent to the first battery array and comprising a plurality of second walls that are secured to each other to form a second unitized structure that is configured to house second battery cells, one second wall of the plurality of second walls is secured to the one first wall of the first battery array and includes a first vertical portion, a second vertical portion spaced apart from the first vertical portion and connecting members connecting the first vertical portion and the second vertical portion.

2. The battery structure of claim 1, wherein the one first wall includes a third vertical portion and a flange portion extending from the third vertical portion toward the second battery array.

3. The battery structure of claim 2, wherein the second vertical portion of the one second wall is spaced apart from the third vertical portion of the one first wall.

4. The battery structure of claim 2, wherein the flange portion is located above the second vertical portion of the one second wall and located above the connecting members of the one second wall.

5. The battery structure of claim 2, further comprising first fasteners extending through the flange portion of the one first wall and through one of the connecting members of the one second wall to secure the one first wall to the one second wall.

6. The battery structure of claim 5, further comprising:
a battery tray configured to house the first battery array and the second battery array; and
a plurality of second fasteners, each second fastener extending through the connecting members and at least partially through a bottom wall of the battery tray to secure the one second wall to the battery tray.

7. The battery structure of claim 1, further comprising:
a battery tray configured to house the first battery array and the second battery array; and
a plurality of fasteners, each fastener extending through the connecting members of the one second wall and at least partially through a bottom wall of the battery tray to secure the one second wall to the battery tray.

8. The battery structure of claim 1, further comprising a third battery array adjacent to the first battery array and connected to another first wall of the first battery array.

9. The battery structure of claim 1, wherein a height of the first vertical portion of the one second wall is greater than a height of the second vertical portion of the one second wall.

10. A battery structure for an electric vehicle, the battery structure comprising:
a battery tray;
a plurality of cross beams secured to the battery tray and spaced apart from each other along a longitudinal direction of the electric vehicle, each cross beam extending in a transverse direction; and
a plurality of battery arrays disposed within the battery tray, the plurality of battery arrays comprising:
a first battery array comprising a plurality of first walls that are secured to each other to form a first unitized structure that is configured to house first battery cells, one first wall of the plurality of first walls includes a first vertical portion and a flange portion extending from the first vertical portion; and
a second battery array adjacent to the first battery array and comprising a plurality of second walls that are secured to each other to form a second unitized structure that is configured to house second battery cells, one second wall of the plurality of second walls is supported by a corresponding cross beam of the plurality of cross beams and includes a second vertical portion, a third vertical portion spaced apart from the second vertical portion and connecting members connecting the second vertical portion and the third vertical portion,
wherein the flange portion of the one first wall is secured to the one second wall.

11. The battery structure of claim 10, wherein the third vertical portion of the one second wall is spaced apart from the first vertical portion of the one first wall.

12. The battery structure of claim 10, wherein the flange portion is located above the third vertical portion of the one second wall and located above the connecting members of the one second wall.

13. The battery structure of claim 10, further comprising a plurality of fasteners, each fastener extending through the connecting members and a corresponding cross beam to secure the one second wall to the battery tray.

14. The battery structure of claim 10, further comprising a plurality of first fasteners extending through the flange portion of the one first wall and through one of the connecting members of the one second wall to secure the one first wall to the one second wall.

15. The battery structure of claim 14, further comprising a plurality of second fasteners, each second fastener extending through each of the connecting members and a corresponding cross beam to secure the one second wall to the battery tray.

16. The battery structure of claim 15, wherein the plurality of first fasteners have a first length and the plurality of second fasteners have a second length, the second length greater than the first length.

17. The battery structure of claim 10, wherein the flange portion of the one first wall abuts again the second vertical portion of the one second wall.

18. The battery structure of claim 10, further comprising a third battery array adjacent to the first battery array and connected to another first wall of the first battery array.

19. A method for assembling a battery structure of an electric vehicle, the method comprising:
disposing a first battery array within a battery tray, the first battery array comprising a first wall including a first vertical portion, a second vertical portion spaced apart from the first vertical portion and connecting members connecting the first vertical portion and the second vertical portion;
securing the first battery array to the battery tray;
disposing a second battery array within the battery tray after the first battery array is secured to the battery tray, the second battery array comprising a second wall including a vertical portion and a flange portion extending from the vertical portion; and
securing the second battery array to the first battery array.

20. The method of claim 19, wherein securing the second battery array to the first battery array comprises inserting a plurality of fasteners through the flange portion of the second wall and through one of the connecting members of the first wall.
